(19) United States
(12) Patent Application Publication
(10) Pub. No.: US 2014/0162230 A1
(43) Pub. Date: Jun. 12, 2014

(54) Exercise demonstration devices and systems

(71) Applicant: Aram Akopian, Yerevan (AM)

(72) Inventor: Aram Akopian, Yerevan (AM)

(21) Appl. No.: 14/096,813

(22) Filed: Dec. 4, 2013

Related U.S. Application Data
(60) Provisional application No. 61/736,311, filed on Dec. 12, 2012.

(51) Int. Cl. G09B 9/00

(52) U.S. Cl. CPC G09B 9/00
USPC 434/256

(57) ABSTRACT

Physical exercise demonstration devices and systems to provide a more enjoyable and motivating experience for the user, who is or wants to become a fan of daily exercising lifestyle.

### CROSS-REFERENCE TO A RELATED PROVISIONAL APPLICATION

This nonprovisional utility patent application is claiming the benefit of a related copending provisional application No. 61/736,311 filed with USPTO on Dec. 12, 2012.

### SUBSTITUTE SPECIFICATION STATEMENT

This substitute specification includes no new matter.

### FIELD OF THE INVENTION

The invention relates generally to physical exercise demonstration devices and systems. More particularly, the invention relates to an improved exercise demonstration robot and its visual analogues.

### PRIOR ART

Research shows that exercise has stronger energizing effects than stimulants like caffeine (Psychological Bulletin 2006 November; 132(6):866-76).

Psychological effects of regular healthy exercising is mood enhancement and stress reduction, as found by many studies, including, among the more recent, reports by Smith et al in J Psychosom Res. 2007 November; 63(5):463-9, and by Sui et al in J Psychiatr Res. 2009 February; 43(5):546-52.

In order to get energized for the day, some of the tips for what to do after waking up in the morning are: exercise, do it with a friend, vary the exercise!

The above advice is not always practical, as far as the friend is concerned, especially in the morning after waking up. Same applies to going to a gym first thing in the morning. Although a popular alternative, fitness exercise programs are however not always on TV at the time someone wants to do them. With this in mind as well, exercise demonstrating robotic systems have been proposed long time ago. But such robotic systems have so far not been mass-produced and marketed, and in view of everything mentioned above, there is need of an exercise demonstration system more entertaining and more enjoyable than the existing aerobics videos and preprogrammed robots.

### SUMMARY

The embodiments of the invention are aimed not to simply demonstrate exercises, but to do it in a much more enjoyable and motivating manner.

One object is to provide exercise demonstration systems with audio accompaniment that is not fixed and can be changed for the pleasure of the user, and thus attract a much wider user base for the said exercise demonstration systems.

In the preferred embodiment, the demonstration system is to be used in the morning, to have an impact at the start of the day.

Also, in the preferred embodiment, the demonstration system is used after its user wakes up having well slept the night before.

Preferably, the exercises being demonstrated are light, to enjoyably produce an energizing effect on the day, in contrast to exhaustive efforts required for other purposes, such as bodybuilding or weight loss.

Thus, the main object is to provide morning exercise demonstration systems, with the said audio accompaniment, that will positively “charge” a person for the day.

These objects are accomplished by the present invention.

According to the invention, there is provided a robot programmed to demonstrate physical exercises under audio accompaniment which is not permanently fixed and is replaceable. The robot may be linked to a wakeup device. Instead of a robot, a visual demonstration device may also be used to demonstrate physical exercises under replaceable audio accompaniment.

### BRIEF DESCRIPTION OF FIGURES

FIG. 1 is an exercise demonstration robot according to an embodiment of the invention.

FIG. 2 is a close-up view of the keypad 8 of FIG. 1.

FIG. 3 is a block diagram of a robot of the invention.

FIG. 4a shows the front of a Wearable Audio Control for the robot of FIG. 1 according to an embodiment of the invention.

FIG. 4b shows a flowchart for the Wearable Audio Control of FIG. 4a.

FIG. 4c shows a neck chain embodiment of a Wearable Audio Control for the robot of FIG. 1.

FIG. 4d shows a wrist bracelet embodiment of a Wearable Audio Control for the robot of FIG. 1.

FIG. 5 is a representation of a robot of the invention in standby mode in a user's room.

FIG. 6 is a flowchart illustrating the daily event sequence that takes place, according to an embodiment of the invention, outside of the times when the robot is demonstrating exercises.

FIG. 7 is the front of a remote control for the robot of FIG. 1.

FIG. 8 is an embodiment of an exercise demonstration robot with a SIM card slot for a wakeup call function.

### DETAILED DESCRIPTION

Throughout this Detailed Description, the following terms are used interchangeably: “audio title”, “music title”, “music”, “song” and “tune”; “rhythm” and “tempo”; “exercise routine” and “exercise sequence”.

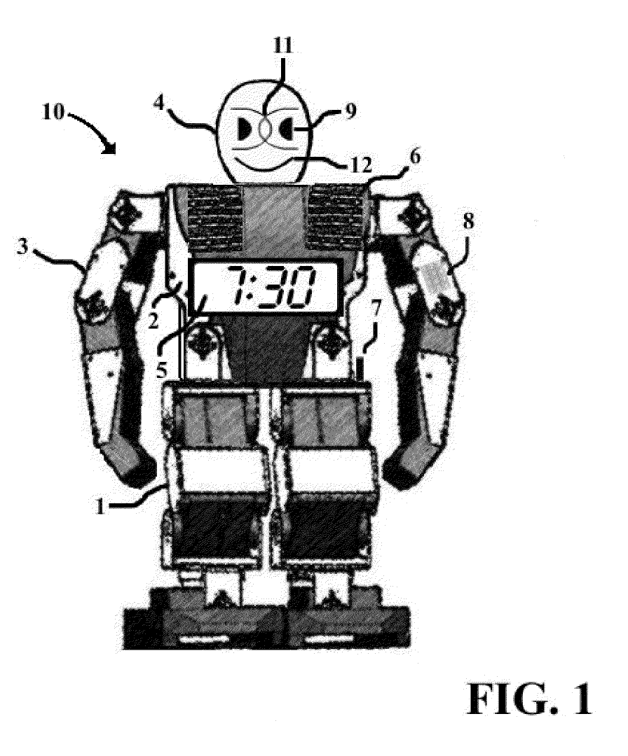

FIG. 1 shows an exercise demonstration robot according to an embodiment of the invention.

Referring to FIG. 1, the robot's body 10 is composed of legs 1, torso 2, arms 3 and head 4. It is made up of aluminium and durable plastic components, and has 20 degrees of freedom of movement. On the front of the torso 2 there is a liquid crystal display of an alarm clock module 5 of the robot. Mounted above it are speakers 6.

On a “hip”-position end of the robot's waistline there is a wireless Internet modem 7 plugged into a USB port. The wireless Internet modem is a mobile broadband modem in the form of a USB stick with an integrated SIM cardholder. The modem allows access for the robot to a 3G or a faster Internet network.

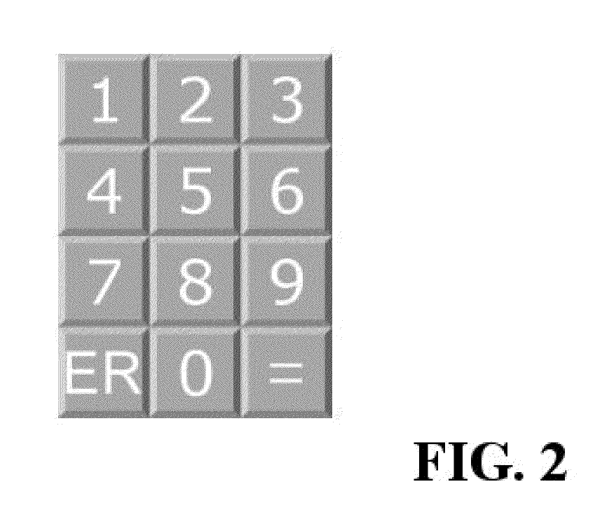

In the “biceps” part of the robot's left arm housed is a keypad 8 for programming exercise sequences. Its buttons are shown and listed in FIG. 2.

The head 4 of the robot is shaped as an oval, close to the contour shape ellipse of a human head. On the front side of the head, the robot's face contains two eye elements 9, a “nose” button 11 between them, and a “smile”12 across the face below the “eyes” and “nose”. The “smile” 12 of the robot is illuminated by LED lighting.

FIG. 2 shows a close-up view of the keypad 8 of FIG. 1.

There are 12 buttons in total, 10 buttons labeled with a number from 0 to 9, one button labeled as “ER”, and one button labeled as “=”.

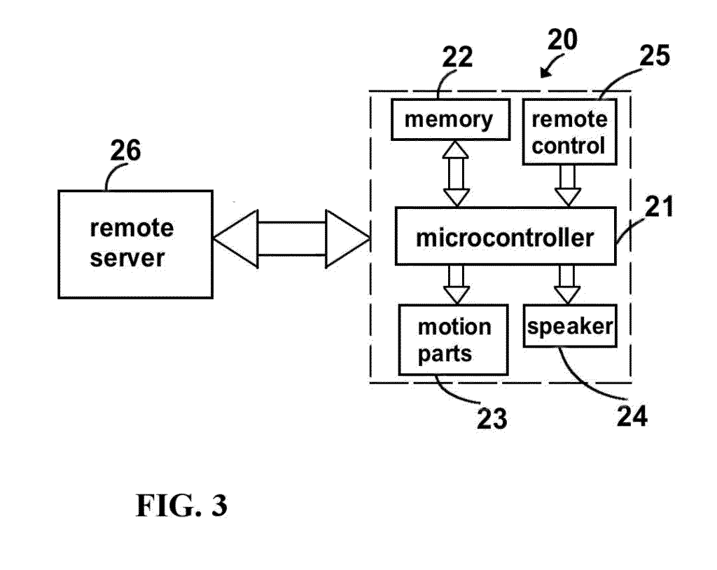

Referring to FIG. 3, depicted therein is a block diagram of an exercise demonstration robot implementing the principles of the present invention.

The robot 20 comprises a microcontroller 21, memory 22, motion parts 23, speakers 24 and a remote control 25. The microcontroller 21 receives data from memory 22, and transfers this data either to motion parts 23, when the said data is motion information data, or to the speakers 24, when the said data is audio information data. The microcontroller 21, the memory 22, the motion parts 23 and the speakers 24 are permanently connected and contained within one housing.

The robot's user can send commands to the robot by using a remote control 25.

The robot 20 can connect through Internet to a remote server 26, with which it can exchange data between the remote server's database and its memory 22.

In the embodiment of FIGS. 1 and 3, the robot makes automatic daily connections with the server of the manufacturer to update content in the robot's memory. The robot's user also can get access to the content of the server by opening through Internet an online account on the website of the robot's manufacturing company.

Programmable toys, including robots, are well known prior art, including numerous patents. The most spectacular example of such robots is probably the dancing robots, as demonstrated in recent years in a number of tech shows (including CES of Las Vegas) and robot festivals, and widely covered by the media.

Some of them can be programmed even by the users, such as the Robonova robot of the South Korean company Minirobot.

There is also a 1975 physical training robot patent describing specifically an exercise demonstration robot (U.S. Pat. No. 3,888,023).

In view of the above, technical details of programming the movements of a robot for demonstration of an exercise will not be included here.

In the present invention's preferred embodiment, a new exercise can be programmed and provided through the server by the manufacturer (automatically downloaded to the robot's memory as content update) or created by the user online using the website's robot simulation program, placed into the Update section of the user's account, and automatically downloaded to the robot's memory as content update in the next daily connection with the server. Such ability by users to create exercises could be useful for programming, for example, Eastern (Chinese) type exercises.

In the preferred embodiment, an exercise routine, i.e. a sequence of exercises to be demonstrated by the robot together at one time, is created by manual programming using a keypad on the robot's body (keypad 8 of FIG. 1). One exercise routine can be created for each day of the week, numbered correspondingly according to the day of the week (1 for Monday, 2 for Tuesday, etc, and 7 for Sunday). Individual exercises themselves are each assigned its number. When delivered by the manufacturer, the robot already contains a large number of exercises preloaded in its memory. The user can find out the numbers corresponding to different exercises available for demonstration by the robot by looking up the brochure with exercise illustrations that comes in the box with the robot. To find out the number behind new exercises (from a manufacturer's update, or ones created online by the user), the user goes to their online account and looks up the numbers in the section New Exercises.

To program an exercise routine with the keypad, the user first presses the button with the number of the day of the week for which the routine is being created, followed by the ER (“Exercise Routine”) button. Then the user again enters the number for the day of the week followed by the sequence number of the exercise in this routine. After pressing these keys, the user presses the “=” key and enters the number of the individual exercise. So, as an example, to create an ex routine for Sunday, the user must press the key “7”, then the key “ER”. To have “standing torso twists” (exercise N14) as the first exercise of the routine, the user then presses “7”, then “1”, then “=”, and then “1” and “4”. For the second exercise of the routine, the user must press “7”, then “2”, then “=” and then the number behind the exercise that they want to be the second in this routine. And so on. When all exercises of the routine have been programmed in this way, the user presses again the “ER” button and the routine gets saved in the robot's memory as the exercise routine for Sunday. In case there was already a routine for Sunday in the robot's memory, it gets overwritten by the newly-created one.

In one alternative embodiment, instead of manual programming, exercise routines tailored to the user's age or health state can be downloaded from the website's server, thus providing exercise routines of suitable intensity/energy level.

In all embodiments of the invention, the audio accompaniment of exercises is not permanently fixed, and is replaceable for entertainment of the user. In the simplest embodiment, such change may be a switch between a commentary-type audio accompaniment of exercises, whereby the user is told how to do the exercise, and musical accompaniment. In most embodiments, however, it is the music accompaniment itself that is changed. It is achieved by applying special software means described below.

Software-enabled determination of music's rhythm is prior art, including U.S. Pat. No. 6,657,117 and U.S. Pat. No. 8,071,869. There is also a publicly-available freeware program for this called MixMeister BPM Analyzer. Based on the technology, by matching one or more pieces of music to an exercise, a suitable rhythm, or even a range of it, may be determined for a particular exercise. The music accompaniment of this exercise can then be replaced by playing other titles of music of the same rhythm level or range.

Finding music with same properties (such as rhythm) in a database is a relatively straightforward task for a software. A variation of this search procedure, when music being searched is further limited be genre and “mood” properties, has also been proposed and patented under U.S. Pat. No. 7,626,111 patent.

The technical details of such software means are known to those skilled in the field, and can also be found in the corresponding patents. They will therefore be omitted here in order not to obscure the descriptions of the embodiments that follow.

In the preferred embodiment, first a number of default tunes of a suitable rhythm, or a range of it, are selected for each exercise by the manufacturer. Based on these rhythm values, a database of more tunes with same values is created, out of which new tune accompaniments are provided for each exercise according to the description that follows.

One of the ways the database grows and gets more tunes is through inclusion of newly released titles for Charts voting by users.

Before being added to the online database, each new title is run through a BPM (beats per minute)-calculating software, and is accepted for inclusion into the database only if its calculated tempo matches the value for an exercise-specific tempo.

In the preferred embodiment for weekly Charts voting, upon access through Internet of their online account users first simply vote for a preferred audio title, then watch simulations of matching exercises (i.e. exercises that can be demonstrated along its tempo) accompanied by it, and, for each said exercise, vote for the best alignment of exercise demonstration movements along the music of the audio title. Each said simulation of a matching exercise shows the robot's demonstration movements executed along the audio title. The user watches this simulation in a video screen box with two horizontal bars under it, one fixed bar the length of the audio track, and another slightly shorter bar of back-to-back exercise movement repeats, the length of the audio track minus 0.5 min.

For the alignment vote, users are offered the automatic blind alignment (with both the song and the exercise demonstration moves starting at the same time), and if it is found by them to be not well aligned, one or more alignments suggested by users in its stead. Each new alignment suggested by a user is automatically compared to alignments already offered for vote, and only an alignment differing from an already proposed one is accepted and included for voting.

To submit an alternative alignment, the user simply drags the shorter bar of exercise movement repeats along the fixed bar of the audio track, watches the resulting demonstration in the video screen above the bars, and if satisfied, clicks the “Submit” button next to the video screen box.

Most fitness experts agree that 5-10 min is the optimal length for a morning exercise sequence to energize and not to tire the person doing it. If a song is 2-3 min long, then such a sequence means a minimum of 3 and a maximum of 5 songs, and thus exercises, per sequence.

As far as each exercise is concerned, the number of repeats of its moves is suggested to be between 12 and 16, in order to work out the muscles involved in these moves without uselessly overtiring them. This number of moves will be executed in around a minute's time, leaving at least half of the song for something other than the exercise in question. This is the main reason that in most 80s aerobics workouts moves for a few different exercises are executed together during one song play. In order to simplify the workout and allow execution of one exercise per one soundtrack, while observing the suggested repeats number for not overtiring muscles during an exercise, in the preferred embodiment of the invention, repeats of an exercise executed during part of the song are preceded by repeats of a “filler” warmup move, and followed by repeats of another “filler” warmup move, during the rest of the song. Examples of such “filler” warmup moves include shoulder shrugs, standing knee bends, lunge stretches while leaning against a support such as a table, etc. These simple warmup moves are tempo-independent and can be performed along any music. In order to avoid overtiring, the number of repeats of a warmup move must also be kept low, preferably around or below half the number of repeats of the exercise.

To realize the above, in the preferred embodiment of the present invention after the above-mentioned alignment of the movements of an exercise with the music of the song, the said song is automatically cut to a 2 min 10 sec long track, by keeping the first 2 min of the audio title, and a further 10 sec fade-out tail. According to the author's experimentation results, a 10 sec fade-out tail after 2 min of a song works very well, producing a standardized length sample that provides for brief 0.5 min warmups before and after 1 min of exercise, while still being representative of the song as a shorter faded-out edit of it.

After the 2 min 10 sec cut, the website's software deletes the portions of the aligned exercise repeats bar outside the central 1 min of the non-faded 2 min audio, i.e. for the first and last 0.5 minutes of the said audio. This data processing step results in that out of the aligned exercise repeats only those fully inside the central 1 min are to be executed during demonstration by the robot, preceded and followed by “filler” warmup moves incorporated as described below.

For each audio title making into the Charts compiled as described below, the software of the website creates an associated file containing information regarding the synchronization of robot's demonstration movements with the music in question. This file contains instructions for the robot's content management software regarding the timing of exercise movement repeats during the said audio title, derived from the alignment option selected online by users' vote. Upon download of the said audio title to a user's robot's memory, along with it downloaded is also the associated file containing information regarding the synchronization of robot's movements with the music in question. In case a few exercises are matching a particular tune, then its associated file contains sets of information regarding alignment of movements for each of these exercises. The robot's content management software selects whichever exercise's set whenever a corresponding exercise is demonstrated within a routine as described further in this detailed description.

It is also the robot's content management software that incorporates a fitting number of evenly-spaced, separated from each other by a 3 second interval, repeats of a warmup move over the first and last 0.5 minutes of the audio title during an exercise demonstration. For each exercise of a routine, its two filler moves are selected by the robot's content management software at random, but to differ from the filler moves of the rest of exercises of that routine.

Music tempo calculating software can determine if there is a significant (above certain threshold) variation of tempo within a song. In one embodiment of the invention, a software filter detecting significant tempo variations in a song disqualifies it from inclusion into the database, even though its assigned tempo value matches that for an exercise.

In another embodiment, such titles with significant tempo variations are placed into the “Mix Music” section of the website, in one half of which users can see what titles have been sorted this way. If a user sees among them a music title they like, they can select and isolate from it a segment of a relevant tempo (i.e. tempo matching that for an exercise), such as the song's verse, or chorus, unless, of course, such a segment carries a tempo variation within itself. This user-isolated segment is then automatically mixed by the website's DJ-type software with a same-tempo beats loop selected by the user from the software's library of such beats, to make a song-length mix of music containing a segment of a released title. The user then may submit the produced mix for a public verdict, whereby it is placed in the second half of the website's “Mix Music” section, where users can vote for the mixes they like. The most popular mixes gaining enough vote, i.e. above certain number of votes, are placed into the general database of titles to compete, on equal terms with non-mix original audio titles, for a place in the Charts.

If a song's tempo has been determined by the software incorrectly, users upon voting can notify the website's moderator about it so that the song's tempo is recalculated correctly, and, if not matching any exercise's tempo, the song is taken out of the database.

In the preferred embodiment, Charts are compiled in the descending order of most popular titles with as many exercise matchings per title as possible. In case not all exercises are matched by the list of 20 first titles making the charts, the titles from the bottom are replaced by those closest below among the voted titles that match the exercises in question.

And when an exercise routine is demonstrated, the music titles for each exercise are selected from the Charts folder of the robot by its software according to the popularity rank (more popular ones selected first) in such a way so that all exercises get an unrepeated accompaniment.

A second way by which the database of music grows is through user-suggested music charts:

a user uploads a music title (with release date older than 3 months not to overlap with the General Charts) and the website's software checks if it could be matched with any exercise.

The technical details of the way to update content between a client and the server are well known to those skilled in the art of software engineering and will not be described here. Only the overall procedure of the way music is updated will be described in the embodiment below.

In the preferred embodiment, the content of the last week's CHARTS folder on the robot's hard drive is compared to the new charts list on the server. If no content, just place differences, then nothing is downloaded, and the whole content of that folder is moved into the newly created (this week's) CHARTS folder.

If differences, then what's absent in the robot's last week's CHARTS folder is downloaded into the new CHARTS folder, and what's present in last week's folder and new charts is moved from the old folder into the new one. The rest of the titles remain in the old CHARTS folder, from where the titles tagged as “Liked” are moved into the folder LIKED NEW, or LIBRARY OF LIKED TITLES in case of user suggested title charts, after which the folder with the rest of the titles is deleted.

In the preferred embodiment of the invention, along with the robot its user is also provided with a control interface to make selections of the audio accompaniment of exercises as they are being demonstrated. The said control is further referred to as a Wearable Audio Control (WAC).

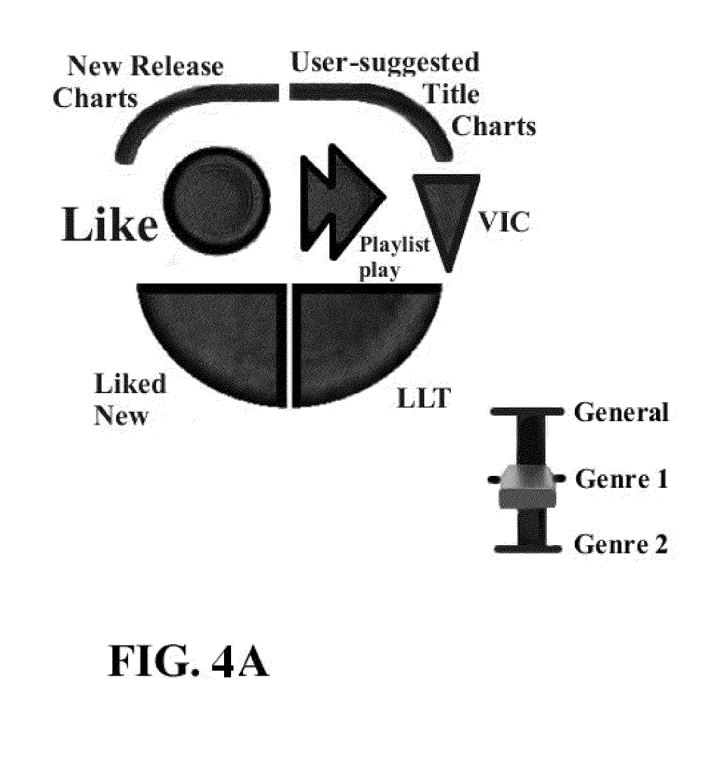

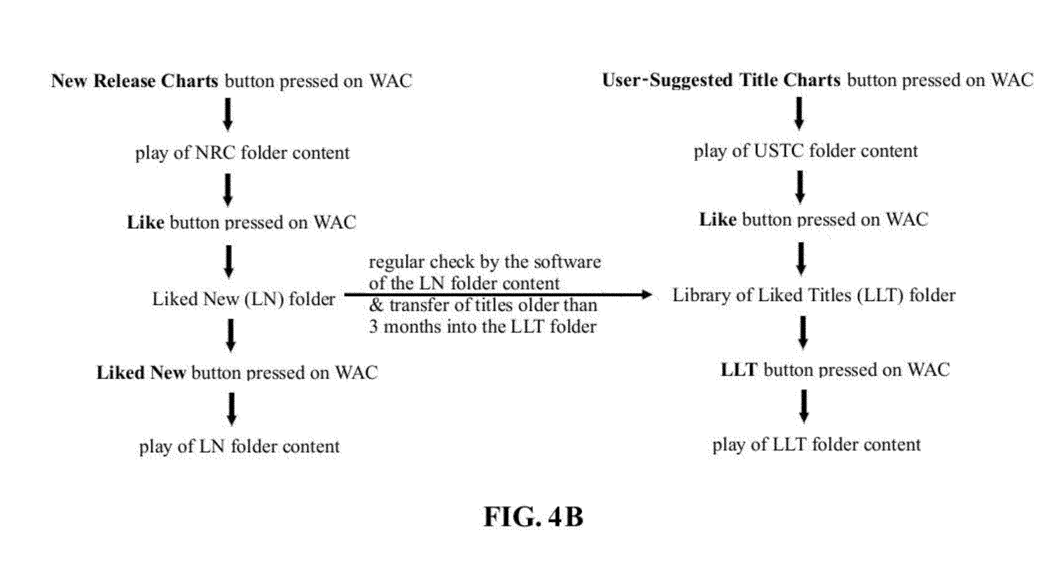

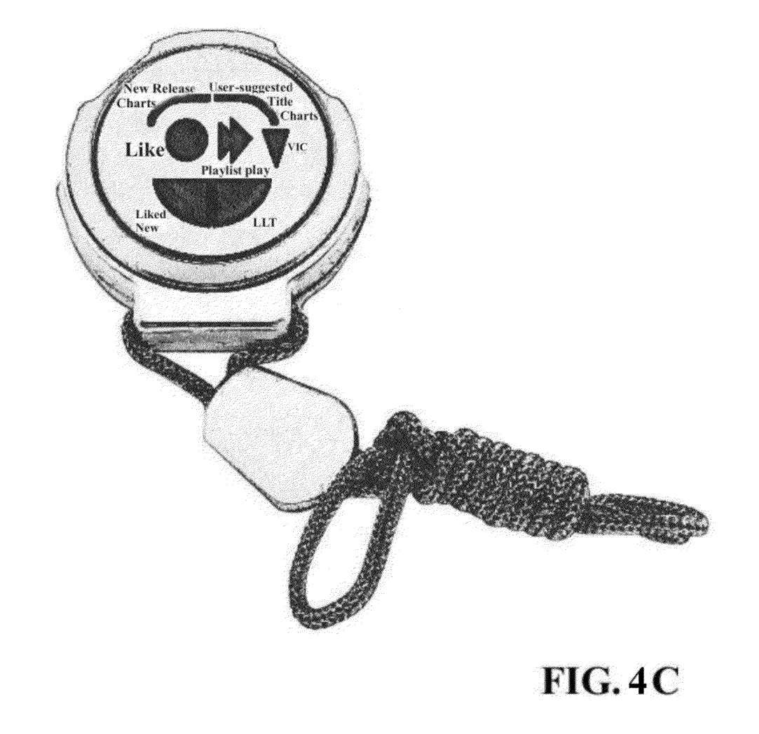

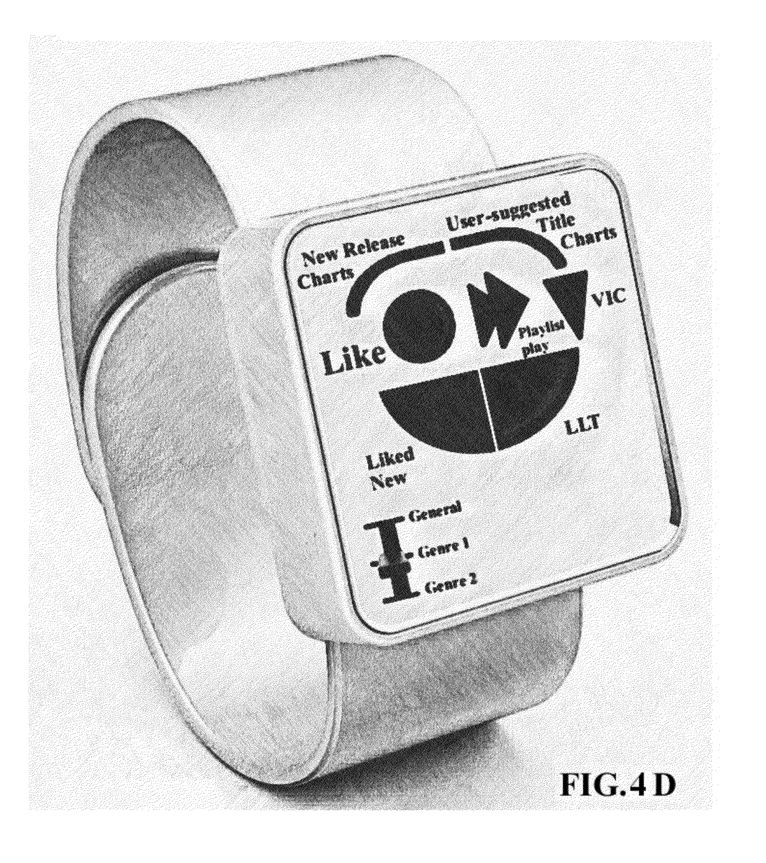

Referring to FIG. 4, depicted therein are embodiments and a flowchart for a Wearable Audio Control (WAC) for the robot of FIG. 1.

FIG. 4a shows the front of the WAC interface, with all its buttons according to an embodiment of the invention. To make a selection of audio accompaniment type at the start of exercises, the user must press any one of the buttons of WAC, except the Like button. What happens upon pressing a button of the WAC is described in FIG. 4b and the text immediately after it.

Referring to FIG. 4b, shown therein is a flowchart of all but two button selections on the WAC. When the New Release Charts (NRC) button is pressed on the WAC by the user, the exercises being demonstrated are accompanied by music titles from the NRC folder in the memory of the robot. Since an exercise is matched by at least one title from that folder, the content of the NRC folder will suffice to cover any exercise sequence being demonstrated by the robot when the user selects the NRC option of audio accompaniment.

Similarly, when the User-suggested Title Charts (USTC) button is pressed on the WAC by the user, the exercises being demonstrated are accompanied by music titles from the USTC folder in the memory of the robot. And again, since an exercise is matched by at least one title from that folder, the content of the USTC folder will suffice to cover any exercise sequence being demonstrated by the robot when the user selects the USTC option of audio accompaniment.

Pressing the LIKE button by the user will have effect only when the NRC or USTC options of audio accompaniment of the exercises have been selected in the beginning. In this case, the robot's software tags the music title, during the play of which the LIKE button was pressed, as “Liked”. These titles tagged as “Liked” are listed by the robot's software in the LIKED NEW folder (in case of titles from the NRC folder), or the LIBRARY OF LIKED TITLES folder (in case of titles from the USTC folder). The listing of the LIKED NEW (LN) folder is regularly checked by the robot's software, and titles listed there for more than 3 months are transferred into the LIBRARY OF LIKED TITLES (LLT) folder.

When the Liked New button is pressed on the WAC by the user, the exercises being demonstrated are accompanied by music titles from the LN folder in the memory of the robot. If not every exercise of a routine is matched by a title in that folder, then the unmatched exercises of the routine are accompanied by titles from the NRC folder.

Similarly, when the LLT button is pressed on the WAC by the user, the exercises being demonstrated are accompanied by music titles from the LLT folder in the memory of the robot. And if not every exercise of a routine is matched by a title in that folder, then the unmatched exercises of the routine are accompanied by titles from the USTC folder.

The WAC must be embodied in such a way as to comfortably allow selection of audio accompaniment while leaving the user's hands free for exercising.

With this end in view, FIG. 4c illustrates a neck chain embodiment of the WAC. In this embodiment, during exercises the WAC is worn as a plastic pendant on a neck chain around the user's neck, allowing comfortable use of the WAC.

FIG. 4d illustrates a wrist bracelet embodiment of the WAC. In this embodiment, the WAC is incorporated into a wrist bracelet and is worn as such during exercising, allowing comfortable use of the WAC.

In one embodiment, a “Genre” setting can be set in the online account by the user so that more than one New Release Charts and one User-Suggested Title Charts are downloaded to the user's robot: as usual without a genre filter, as well as charts of the user's preferred genre music. Preferably, two such “Genre” settings could be set in the account, demanding for download of two genre-specific New Release Charts (ex. Rock music-specific and Electronic music-specific) and two same genre-specific User-Suggested Title Charts.

And when the user wants to have a genre-specific audio accompaniment of an exercise routine, they simply slide the indicator handle on the filter switch of the WAC of FIG. 4a to the corresponding Genre setting, before pressing either the NRC or the USTC button.

In order to ensure adequate number of users voting for Charts, in the preferred embodiment there are three options of access to the server:

one at a regular monthly subscription price with possibility and not requirement to vote on charts,
one at a discounted monthly subscription price with requirement to vote on charts,
& one free with limited content access.

In the preferred embodiment, users can also create playlists out of their “Liked” titles.

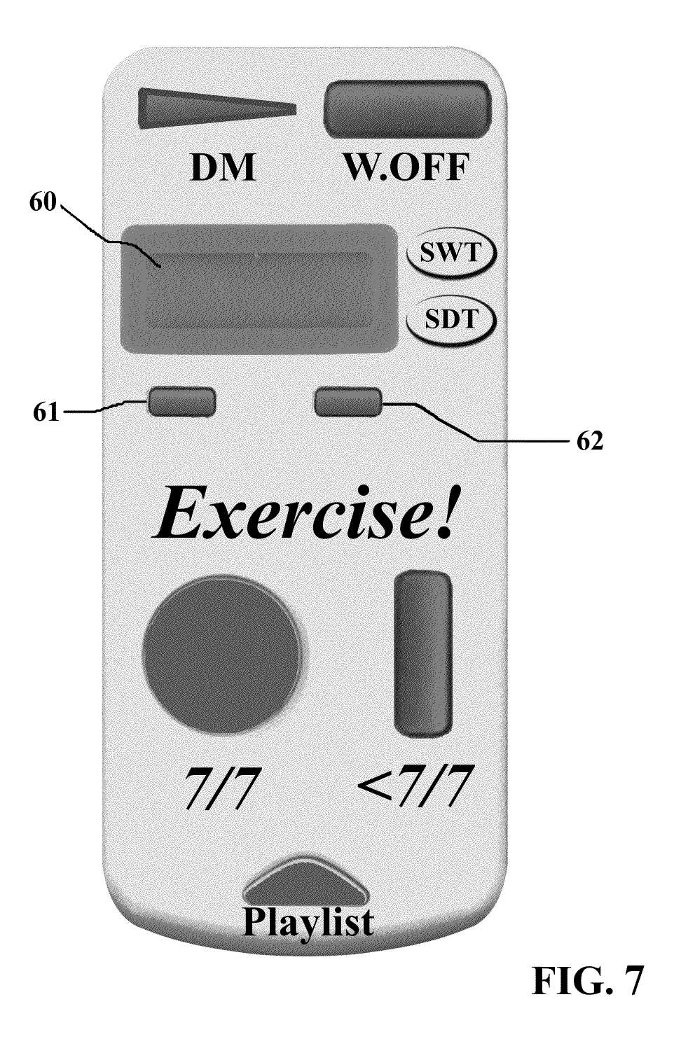

They press the Playlist button on the remote control of FIG. 7, after which the robot establishes Internet connection with the website and uploads all the Liked title names from its memory into the user's account on the website. All the exercise routines are also uploaded from the robot's memory. In order to create a Playlist, the user then opens the Playlist section in their online account. Two windows appear, one displaying side by side the exercise routines each in the form of a column of exercise names listed below each other in the corresponding order, and the other window displaying all Liked titles uploaded from both the “LIKED NEW” folder and the “LIBRARY OF LIKED TITLES” folder in the robot's memory. The user then goes to the first window and clicks on the first exercise in the column of an exercise routine. Upon that, the website's software finds and highlights in the second window all titles that would match the selected exercise. The user then selects the preferred title out of the highlighted ones, and it is thus added to the playlist being made. The user then clicks on the next exercise name in the routine, and the procedure gets repeated. And thus until music titles are selected for all exercises of a routine and a playlist is completed.

In the preferred embodiment, users are able to create more than one playlist per exercise routine, provided that the number of uploaded Liked titles is large enough to permit the website's software offer a choice of alternatives for the exercises of a routine.

When the user presses the Playlist Play button of FIG. 4a on the WAC, the robot's software checks if there is a playlist created for the exercise routine being demonstrated, and if yes, plays it as the routine's audio accompaniment. If the user in this case presses the Playlist Play button again, then the robot's software checks if there is in the memory another playlist created for the same routine, and if yes, skips to this playlist as the routine's audio accompaniment.

Otherwise, if, upon pressing the Playlist Play button by the user, the robot's software finds in the memory no playlist for the routine being demonstrated, then no audio accompaniment is started, prompting the user to press another button on the WAC for an alternative audio accompaniment selection.

In the preferred embodiment, the user has also the option of having the exercises being demonstrated under voice instruction commentary (VIC) instead of music accompaniment.

In this VIC accompaniment of exercises, preferably all but one exercise of a routine are accompanied by commentary, with only the last exercise being accompanied by music. In an alternative embodiment, both the first and the last exercises of the routine are accompanied by music. The music titles incorporated into a VIC accompaniment are selected by the user through their online account similarly to the way playlist titles are selected for an exercise routine. The user goes to the first window of the screen and clicks on the last exercise in the column of exercise names of a routine. The website's software highlights matching titles in the second window, out of which the user can select their preferred one. This selected title becomes the music accompanying the last exercise of the given routine in the VIC accompaniment option, like sort of an anthem in the end of the routine demonstrated under VIC. In an alternative embodiment, the user in the same way selects a music title for the first exercise of the routine as well, so that the VIC accompaniment of the said routine begins and ends with music.

When the user presses the VIC button of FIG. 4a on the WAC, the robot's software checks if there is a VIC accompaniment created for the exercise routine being demonstrated, and if yes, plays it as the routine's audio accompaniment. Otherwise, if, upon pressing the VIC button by the user, the robot's software finds in the memory no VIC accompaniment for the routine being demonstrated, then no audio accompaniment is started, prompting the user to press another button on the WAC for an alternative audio accompaniment selection.

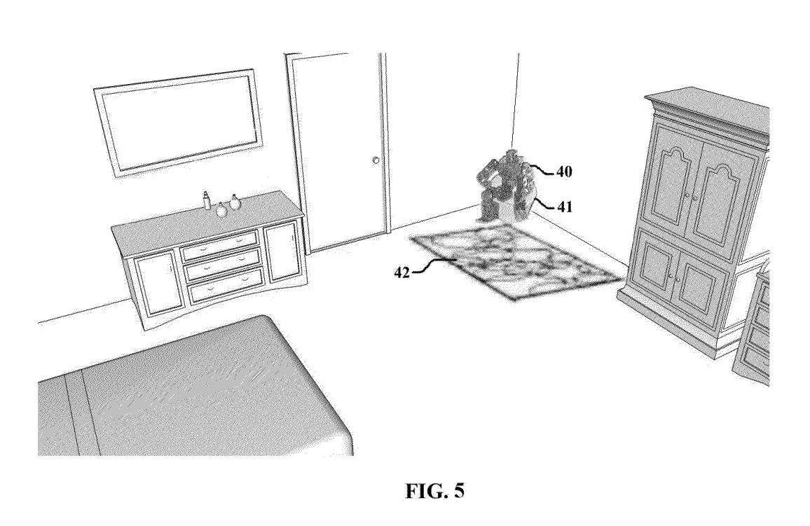

FIG. 5 is a representation of a robot of the invention in standby mode in a user's room.

The robot 40 is sitting on its charging dock 41 in the shape of an ottoman, with its arms on its knees. For the best mode, the charging dock base 41 is placed in a far corner of the room, in front of where the user would be able to exercise, as, for example, is shown in FIG. 5.

The robot's sensors allow it to walk up to and sit on the charging dock without any help from the user. The self-charging capability of robots has already been developed for some time and is a known prior art, not described herein. Commercial robots such as Aibo and i-Cybie robot dogs of Sony and Tiger Electronics respectively, as well as the iRobiQ robot of Yujin Robot company, Korea, and Papero robot of NEC, Japan, include in them such self-charging function.

Sitting on the dock is the robot's standby mode. The standby mode is the robot's mode outside of its active functions. And it is during the standby mode that the robot's battery gets recharged when the power level drops low. The battery charger circuit of the dock automatically turns on to the charging mode when the robot's battery voltage gets below a preset level, and automatically shuts off when the battery becomes fully charged.

In order for the robot to be able to move and demonstrate exercises without hindrance from any objects of the room on its way, the robot's movement and demonstration area is covered by a pressure-sensitive floor mat 42. The technical workings of such mats are well-known to those skilled in the art, and will not be detailed here.

In the preferred embodiment of the present invention, the pressure-sensitive mat 42 of FIG. 5 is automatically activated when the robot gets into standby mode, i.e. sits on the charging dock. If an additional weight of an object is applied to the mat at that time, this closes the normally open electric circuit of the mat and a beeping alarm signal turns on. The alarm signal continues until the weight of the extra object is removed from the floor mat's surface. This allows for the robot's movement space to be securely free from unwanted obstacles.

When allocating the robot's standby dock and the floor mat their space in a room, the user programs the robot's path from the standby dock to the center of the floor mat by using the keypad 8 of FIG. 1 according to the manual's instructions. The keypad allows to program how many steps and in what direction the robot must make after standing up from its charging dock to come to the center of the floor mat for demonstrating exercises. To facilitate and accelerate the robot's return onto the charging dock of the standby mode, the user also programs the steps of the robot from the floor mat center back to the dock. These programmed steps are used by the robot at the end of an exercise demonstration as a rough path approximation for return onto the charging dock, corrected by the end of the path by the robot's sensor capability, as in the examples of prior art for self-charging given above.

The self-charging and obstacle-free movement capabilities of the robot are required to provide for autonomous activity of the robot, which is essential in allowing the user not to have to look after the robot as a baby and thus in establishing a more meaningful relationship of the user with the robot and allowing the robot not to be viewed by its user as a joke or a silly toy.

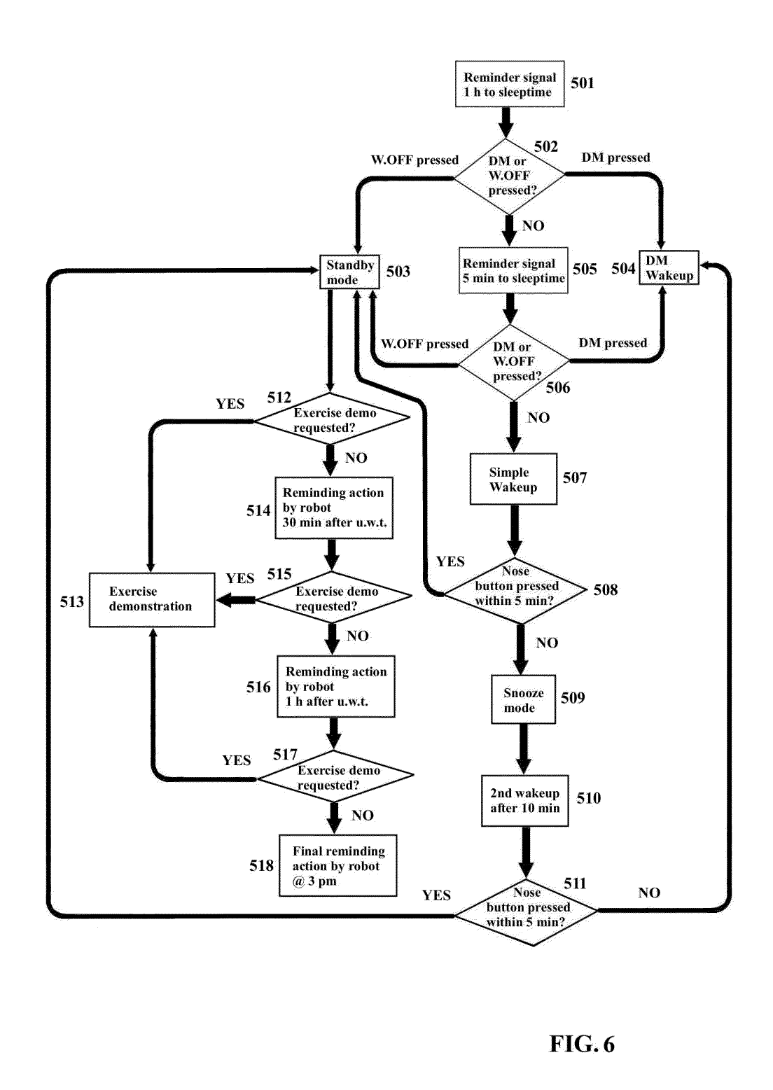

In one possible embodiment, the robot of the present invention includes a function of being automatically activated upon its user's wakeup from sleep. Preferably, the user is woken up by an alarm clock signal from an alarm clock unit within the robot's body as in FIG. 1, and the robot is automatically activated at the same time from its standby mode. This is further detailed below in the description of FIG. 6.

Referring to FIG. 6, shown therein is a flowchart illustrating the daily event sequence that takes place, according to an embodiment of the invention, outside of the times when the robot is demonstrating exercises.

At step 501, every evening, 1 hour prior the usual time that the user goes to sleep, hereafter referred to as the “usual sleep time”, a double beep signal is produced by the robot to remind the user to make selection of the way they wish to wake up tomorrow morning. The usual sleep time is programmed into the robot's memory using the keypad 8 of FIG. 1 according to instructions that come in the robot's manual. The double beep signal produced by the robot is similar to the hourly time signal on electronic hand watches whereby the watch beeps twice every hour on the hour.

At step 502, after this reminder the user has time to make selection before going to sleep. If the user presses the W.OFF button on the robot's remote control, then at step 503 the robot goes into standby mode. If the user presses the DM button on the robot's remote control, then at step 504 the robot wakes up the user next morning at the usual wakeup time with a “drill mode” wakeup. The usual wakeup time is preset by the user in a manner similar to setting the usual sleep time, according to instructions that come in the robot's manual by using the keypad 8.

The so-called “Drill Mode” wakeup is a special function of the robot helping its user to wake up when they have difficulty to do so on their own, but really need to. This is the case when someone has not slept well, but, for example, does need to get up to go to work.

In this drill mode, the robot first turns on for 15 seconds an imposing alarm sound like those used as a modern factory's emergency alarm.

It then starts doing the first of a two-exercise set of “Drill mode”-specific exercises from its manufacturer-preloaded exercise collection, and uses voice commentary urging the user to get up and do the same moves. The principle of these “Drill mode” exercises is as following. Since both the “fight or flight” reflex of the body and its waking up are found to be regulated by the same neurotransmitter noradrenaline (aka norepinephrine), physical exercises that mimic best a fight-or-flight situation should be most helpful in making someone wake up, even if not well-slept or tired.

Such exercises, for example, can often be seen performed by sprinters or soccer players in the warmup before their runs and games respectively. To provide an example, probably the best-known one of such exercises is an exercise called “walking lunges”.

In the present invention, these exercises are employed for the “Drill mode” waking up of the user, and are correspondingly tagged as “Drill mode”-specific. Preferably, the “Drill mode” exercises are demonstrated as two-exercise sets and are accompanied only by the robot's voice instructions, without any music accompaniment.

If the W.OFF or DM buttons are not pressed by the user by 5 min prior the usual sleep time at step 502, then at step 505 at that time, i.e. 5 min prior the usual sleep time, another double beep signal is produced by the robot. At step 506, anytime after this reminder and before the usual wakeup time the user can make a selection for the wakeup mode next day. If the user presses the W.OFF button on the robot's remote control, then the robot goes into standby mode of step 503. If the user presses the DM button on the robot's remote control, then the robot wakes up the user next morning by the DM wakeup of step 504 as described above.

If no selection is made by the user at step 506, then the robot wakes up the user next morning in the “Simple Wakeup” mode at step 507. In this “Simple Wakeup” mode, the user is woken up at the usual wakeup time with a 15 second long wakeup signal. In one embodiment of the invention, a favorite music title of the user may be played by the robot in the simple wakeup mode like an anthem for rising and getting out of bed. The music title may substitute for the 15 sec long wakeup signal, or one may be followed by the other. This music title may be selected by using the robot's WAC of FIG. 4 and the keypad 8 of FIG. 1, according to the instructions of the robot's manual.

During the simple wakeup of step 507, the frame around the robot's LCD display of the alarm clock module 5 lights up and begins blinking. In addition to this, the robot slowly performs a hand salute.

At step 508, the user has 5 min after the wakeup signal to get up, walk up to the robot, and, as a sort of a friendly greeting, acknowledge the waking up by pressing the robot's “nose” button 11.

Upon pressing of the nose button, the robot's smile 12 lights up wide to its full extent. It then quickly goes to being lit up to a length, from its center, proportionate to the frequency of non-DM exercising done by the user in the past five days.

The smile 12 stays lit up wide to its full extent on a day the user has exercised, and decreases afterwards in length with each day of robot's non-use for demonstrating exercises. In the invention's preferred embodiment, the LED light of the robot's smile 12 is automatically switched off after the usual sleep time and lights up next morning only after the usual wakeup time. It does so at either step 508 or step 511, whenever the nose button 11 is pressed, in case no selection was made at step 506, or at step 503 in case the W.OFF button was pressed at steps 502 or 506. The smile does not light up next day if the step 504 has taken place on that day.

If at step 508 the nose button is pressed within 5 min, then the robot enters into standby mode of step 503. If the nose button is not pressed within the said 5 min at step 508, then the robot enters into Snooze mode at step 509.

At step 510, 10 min after entry into Snooze mode the user is woken up by another 15 sec long wakeup signal or favorite music title as above at step 507. The frame around the robot's LCD display of the alarm clock module 5 lights up and begins blinking again. This time, in addition to this, the robot does not make a hand salute, but waves with one arm as if to call the user's attention.

At step 511, the user has 5 min after this second wakeup signal of step 510 to get up and press the robot's nose button. If at step 511 the nose button is pressed within 5 min, then the robot enters into the standby mode of step 503. Otherwise, the robot immediately wakes up the user with the DM wakeup of step 504.

Whenever the robot enters into the standby mode of step 503, if at the next step 512 an exercise demonstration is requested by the user via the robot's remote control within 30 min after the usual wakeup time, then at step 513 the robot demonstrates to the user an exercise routine as per preferred embodiment of the present invention.

If at step 512 no exercise demonstration is requested by the user within 30 min after the usual wakeup time, then at step 514 the robot waves with one arm to call the user's attention.

At step 515, if an exercise demonstration is requested by the user within 1 h after the usual wakeup time, then the robot begins exercise demonstration at step 513. Otherwise, at step 516 the robot makes a simple stretching movement under a sound of rusty metal squeak to remind the user in a euphemistic way about the benefit of exercising. The said stretching movement at step 516 may be, for example, simply a rotation of the head, or swinging of the arms.

At step 517, if an exercise demonstration is requested by the user prior to 3 pm, then the robot proceeds to step 513. Otherwise, at step 518, at 3 pm the robot makes the final daily reminding about exercise demonstration by waving with one arm to call the user's attention.

In the preferred embodiment of the invention, after three days in a row without exercise demonstration requested, at step 518 instead of simply waving with one arm to call the user's attention, the robot stands up, moves to its demonstration mat (the pressure-sensitive floor mat 42 described earlier) and boastingly does a series of push-ups to try to motivate the user to exercise.

Referring to FIG. 7, in the preferred embodiment of the invention a remote control is provided for the robot, to facilitate some of the above-mentioned steps of FIG. 6.

Shown in FIG. 7 is the front of the said remote control. The remote control is of a rectangular shape similar to the common shape of remote controls for TV sets and air conditioners.

The DM and W.OFF buttons are pressed by the user when selecting the wakeup mode for the next day at steps 502 and 506 of the FIG. 6 flowchart.

In case the user wishes to be woken up by Simple wakeup of step 507 or by DM wakeup of step 504 at a time other than the usual wakeup time, they can set their preferred out-of-the-ordinary wakeup time for tomorrow by pressing the SWT button (standing for Special Wakeup Time) or SDT button (standing for Special Drill Time), then selecting the desired wakeup time using the time-setting buttons 61 and 62, and confirming the programming by pressing again the SWT o SDT buttons respectively. The time being selected is shown on the LCD screen 60.

The buttons immediately below the remote's inscription “Exercise!” allow the user to start an exercise routine demonstration by the robot at step 513 of the FIG. 6 flowchart. If the user will be or has been exercising daily, they should press the large round button labeled as “7/7”. When this button is pressed, exercise routines are demonstrated according to the day of the week assigned to each by the user when creating them, as described in the beginning of this Detailed Description. If the user will not be or has not been exercising every day, they should press the smaller rectangular button labeled as “<7/7”. When this button is pressed, exercise routines are selected by the robot at random, but ensuring that the selected routine is different from the last previously demonstrated one.

Finally, the arrowhead-shaped button at the very bottom of the remote control, labeled as “Playlist”, must be pressed by the user when they want to create a playlist out of their liked music titles as an audio accompaniment of an exercise routine. It makes the robot upload into the user's online account all the liked titles and exercise routines of the robot's memory for playlist creation by the user, as described earlier within the description of FIG. 4.

A preferred embodiment of an exercise routine demonstration described next is disclosing in detail the best mode of robot's actions during the said demonstration. It includes the following steps.

In a first step, when instructed via its remote control to demonstrate exercises, the robot produces a joyful-like “device activation” sound (for example, “vzvzvz”).

In a second step, the robot stands up from the charging dock and walks to the center of the demonstration carpet. It does so by a bodybuilder-like walk: with hand parts closed into fists and arms out (as if carrying shopping), swaying them back and forth.

In a third step, the robot makes a “Let's get started” gesture. It may be, for example, the That greeting, i.e. a slight bow with palms pressed together in a prayer-like fashion. It may also be a robot's “own” special greeting, designed specifically for the said exercise demonstration robot of the present invention. For example, in one such greeting the robot may “kiss” one of its “bicepses” before bowing down.

In a fourth step, the robot begins demonstrating an exercise routine according to exercise and audio selections of the invention's preferred embodiment as described earlier in this Detailed Description. As a single precise example of specific audio titles matched with exercises, one such possible routine may include “standing torso twists” as its first exercise accompanied by “Black or White” of Michael Jackson (BPM=104), “alternate arm stretches to the ceiling on alternate toes” as its second exercise accompanied by “Moves like Jagger” of Maroon 5 (BPM=127), “hip rotation” as the third exercise accompanied by “500 miles” of The Proclaimers (BPM=132), “knee rotation” as the fourth exercise accompanied by “Get the party started” of Pink (BPM=130), and “bodyweight squats” as the fifth exercise of the routine accompanied by “We will rock you” of The Queen (BPM=107).

In a fifth step, after finishing demonstration of an exercise routine, the robot bids farewell before heading back to the Standby mode corner to sit down on the charging dock. As such farewell, the robot may put a hand part on its chest and bow, then with both hand parts clasped above head (as if in sign of solidarity), say “Have a nice day!” Or alternatively, it may applaud, after which put both fists up, high above the head, with arms bent as if holding the ends of a shoulder-to-shoulder long bar, slightly bow down the head, then say “Have a nice day!” Otherwise, as yet another possible farewell, the robot may do a cartwheel and say “Have a nice day!” while waving with a hand part.

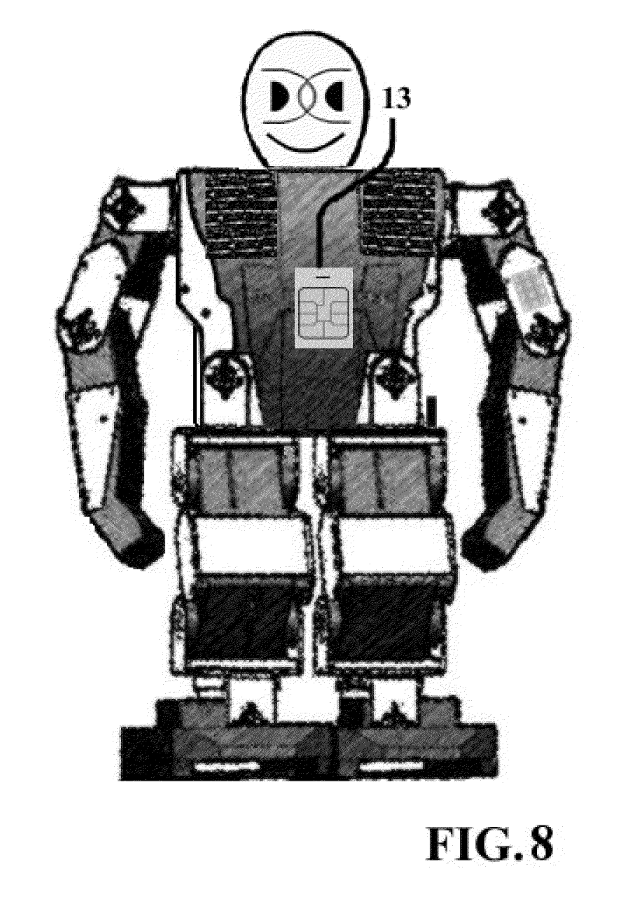

Referring to FIG. 8, shown therein is an alternative embodiment of the robot of FIG. 1.

The robot of FIG. 8 comprises the same elements as the robot of FIG. 1, with the exception of the alarm clock module 5 of the robot of FIG. 1 being substituted in the robot of FIG. 8 by a phone line unit 13.

In the embodiment of FIG. 8, the user's wakeup event is signaled not by activation of an alarm clock module as in the robot of FIG. 1, but by a wakeup call to the phone line unit 13.

The phone line unit 13 functions using SIM card technology, and above the SIM card logo on the robot's body there is a card slot for placing there a SIM card of a cell phone network.

In the embodiments whereby the robot is activated upon its user's wakeup event, the wakeup device, such as alarm clock, may make part of the robot, or the robot may be linked to it, or be capable of being activated by a wakeup device.

A robot is not the only exercise demonstration system of the present invention. In an alternative demonstration system with replaceable audio accompaniment, exercises are demonstrated not by a robot, but by an artificial animated character. The animated character may be a graphic animation character, a CGI character, an animated computer avatar, or the like.

Individual exercise movements demonstrated by the said animated character are drawn using commercially or freely available programs well-known to those skilled in the art, and employed in the form of digital video files.

In the preferred embodiment, the visual demonstration device used in the method is a large screen plasma display TV set of a household. Exercise and audio accompaniment content management, as well as Internet connection, are done through a media device attached to the TV, such as, for example, the Microsoft's X-box 360 or Sony's Playstation 3.

In one embodiment, the demonstration system may be provided as a multimedia software package, without any hardware coming with it except a WAC as in FIG. 4.

In this embodiment, the said multimedia software package comprises a content management software and a multimedia library of exercise demonstrations, whereby each individual exercise demonstration is provided in the form of a digital video file, and one or more of default music titles, in the form of digital audio files, linked to this video file. The software package is installed onto and stored in the media device attached to the TV.

The possibility of updating content is enabled through a remote database server. The content management software makes automatic daily connections with the said server. New exercises, whenever provided through the server, are automatically downloaded by the content management software as content update of the multimedia library.

The content management software allows the user to program exercise routines out of individual exercises by using the remote control of the TV, according to the instructions of the said software.

The audio file accompaniment of exercises is made replaceable through the above-mentioned remote server database, using same software means as described for an exercise demonstration system by a robot. Users' contribution to the process is done through an online account on the public website of the server, again as described for an exercise demonstration system by a robot.

A Wearable Audio Control (WAC) of FIG. 4 with the same functions is also provided in this method.

The alignment of exercise movements along an audio title is done online similar to the way it is done in the preferred embodiment for a demonstration system by a robot. In this case, however, users watch not a simulation of exercise movement repeats back-to-back along the music, but play of the corresponding exercise repeat's video file back-to-back along the said audio title. And upon download of an audio title to the user's multimedia device memory, along with it downloaded is also the associated file containing instructions for the content management software regarding the timing of playing the exercise repeat's video file during the said audio title, the said instructions being derived from the alignment selected by users online. The filler moves are incorporated into an exercise demonstration by the content management software as in the preferred embodiment for a demonstration system by a robot.

In order to make the animation demonstration acceptably presentable and not jolty, the digital video files of filler move repeats and exercise repeats aligned as above must be further supplemented with editing tricks of visual productions. Thus, in the preferred embodiment of the demonstration system by an artificial animated character, every video file of a filler move repeat is produced with a 1 second long segment where the character is smiling and blinking prior to starting execution of the filler move the next second. This 1 sec long segment is then cut from the filler move video file into a separate associated video clip. During demonstration, the content management software covers any intervals before and between filler move repeats by playing in loop its associated 1 sec clip of the character smiling and blinking.

As to the interval of the transition between a filler move's last repeat and the first repeat of an exercise, the content management software covers it during demonstration with a countdown animation effect.

In the standby mode of the demonstration system in this method, the animated character is displayed in a screensaver fashion in one of its many resting poses (with only minimal movement now and then) doing nothing.

The daily event sequence that takes place, in the simplest embodiment given here for illustration purposes only, outside of the times when the character is demonstrating exercises, is as following. Since the TV is often in the living room, in the simplest embodiment of the method there are no waking up steps involved. Unless an exercise routine demonstration has been requested by the user via the TV's remote control, from 9 am to 3 pm the animated character is displayed in the screensaver mode as described above, most of each hour's time just bored. Once every two hours in this period between 9 am and 3 pm the animated character tries to call the user's attention, by waving at the user from screen, or boastingly doing a series of push-ups one day, pull-ups another day, and splits yet another.

In the simplest alternative embodiment to the one above, an additional step of activation of the visual demonstration device upon user's wakeup event is added to the exercise demonstration method.

By way of example, a wakeup timer of a hotel room TV may be programmed to wake up the user at their selected time by switching on the TV set and automatically starting at any time point after waking up the standby mode display on screen of the method's animated character. In this embodiment, the standby mode display of the character may occupy only part of the screen and not be a screensaver.

In one of embodiments of the above method, a collection of artificial characters is provided in the method's multimedia package, and the exercises may be demonstrated by any one character selected by the user out of the said collection. In another embodiment, the exercises may be demonstrated by a multi-character group of two or more characters at the same time.

In another exercise demonstration method of the present invention, a visual demonstration device displays a prerecorded demonstration of exercises by human instructors, the said demonstration having a replaceable audio accompaniment.

In the preferred embodiment of this method, everything involved is the same as in the method of exercise demonstration by an artificial animated character as described above, except that instead of digital video files of character animations, digital video files of prerecorded exercise demonstration by human instructors are employed in this method. The other few small differences with the animated character method are highlighted below.

To make the video demonstration not jolty, every video file of a filler move repeat is recorded with a 1 second long segment where the instructors are smiling and blinking prior to starting execution of the filler move the next second. This 1 sec long segment is then cut from the filler move video file into a separate associated video clip. During demonstration, the content management software covers any intervals before and between filler move repeats by playing in loop its associated 1 sec clip of the instructors smiling and blinking.

Also, during the same demonstration of an exercise, the transition between a filler move's last repeat and the first repeat of the exercise is carried out by the content management software through a transition effect known as “page roll”.

The transition between two different exercises demonstrated within a routine is carried out by the content management software using a video effect popularly known as “fast forward”.

Also, to have some instructor-type commentary at least remotely reminding of traditional aerobics videos, within a routine each exercise before its demonstration gets announced by a voiceover, with a preview clip of the exercise shown during the announcement. “Let's do a (name of the exercise, “hip rotation” being used here as an example) hip rotation like this after some warmup moves!” is one of many possible examples of such announcement over a preview clip of the exercise.

Finally, one more difference with the method of exercise demonstration by an animated character in the given preferred embodiment is that in standby mode of the demonstration system in this method, instead of the animated character in a resting pose, shown is a short compilation clip of exercise movements by the instructors from demonstrations of three different exercises. A series of such compilation clips for the method's standby mode are provided in the multimedia library of the software package, and on a daily basis one is randomly selected from them by the content management software for display in that day's standby mode.

An additional step of activation of the visual demonstration device upon user's wakeup event may also be added to this method, with the same exemplary embodiment as for the animated character method.

Although the invention has been described in detail herein, it is not limited to the embodiments herein disclosed. Various changes and modifications may be made thereto by those skilled in the art without departing from the spirit or scope of the invention.

For example, in one embodiment, the robot may be designed not in a recognizable robot shape but as a popular cartoon or game character. In another embodiment, the robot may be designed as an upright standing toy animal.

In yet another embodiment, video and motion detectors could enable the robot to monitor whether the user has got up out of bed and is performing the exercises along the robot.

It is therefore understood that the invention is to be limited only as specified in the appended claims.

1. A robot programmed to demonstrate physical exercises, whereby the audio accompaniment of an exercise is not permanently fixed and can be replaced.

2. A robot of claim 1, the said robot including a function of being activated upon its user's wakeup event.

3. A robot of claim 2 where the user's wakeup event is signaled by activation of an alarm clock unit within the robot's body.

4. A robot of claim 2 where the user's wakeup event is signaled by a wakeup call to a phone line unit within the robot's body.

5. A wakeup system comprising: 1) a robot programmed to demonstrate physical exercises,
2) a wakeup device through which the said robot is activated upon its user's wakeup event.

6. A method of demonstrating physical exercises, comprising:
providing a robot programmed to demonstrate physical exercises,
and providing means for the user of the robot to make the audio accompaniment of the said exercises not permanently fixed and replaceable.

7. A method of waking up a person comprising:
providing a robot programmed to demonstrate physical exercises,
and providing a wakeup device through which the said robot is activated upon a wakeup event.

8. A method of demonstrating physical exercises, comprising:
providing a visual demonstration device whereby the physical exercises are demonstrated by an artificial character, and whereby the audio accompaniment of the said demonstrated exercises is not permanently fixed and is replaceable.

9. A method of claim 8, wherein the artificial character is an animated character.

10. A method of claim 8, wherein the exercises are demonstrated by more than one artificial character.

11. A method of demonstrating physical exercises, comprising:
providing a visual demonstration device which displays a prerecorded demonstration of the said exercises by human instructors, whereby the audio accompaniment of the said demonstrated exercises is not permanently fixed and is replaceable.

12. A method of claim 8 further comprising providing a wakeup device through which the said visual demonstration device is activated upon its user's wakeup event.

13. A method of claim 9 further comprising providing a wakeup device through which the said visual demonstration device is activated upon its user's wakeup event.

14. A method of claim 10 further comprising providing a wakeup device through which the said visual demonstration device is activated upon its user's wakeup event.

15. A method of claim 11 further comprising providing a wakeup device through which the said visual demonstration device is activated upon its user's wakeup event.
